(19) United States
(12) Patent Application Publication
(10) Pub. No.: US 2004/0052529 A1
(43) Pub. Date: Mar. 18, 2004

(54) WDM transmission link design

(76) Inventors: Richard Lauder, Earlwood (AU); Chia Seiler, Bairnsdale (AU); Brian Robert Brown, Collaroy (AU); Jennifer Bryce, Potts Point (AU); Peter Chart, Balmain (AU); Trefor Morgan, Carlton (AU)

Correspondence Address: CHRISTIE, PARKER & HALE, LLP, 350 WEST COLORADO BOULEVARD, SUITE 500, PASADENA, CA, 91105, US

(21) Appl. No.: 10/076,944

(22) Filed: Feb. 15, 2002

(51) Int. Cl. H04J 14/02; G02B 6/28

(52) U.S. Cl. 398/82; 398/81

(57) ABSTRACT

A WDM system comprising a first WDM module having a first multiplexer unit for multiplexing a WDM optical signal, a second WDM module having a first demultiplexer unit for demultiplexing the WDM optical signal, and wherein the system is arranged, in use, such that optical losses experienced by individual channels of the WDM optical signal in the first multiplexing unit and the first demultiplexing unit and optical losses experienced by the channels during un-amplified transmission between the first and second WDM modules are substantially balanced.

### FIELD OF THE INVENTION

The present invention relates broadly to a WDM system and to a method of transmitting a WDM signal.

### BACKGROUND OF THE INVENTION

A WDM optical signal point-point transmission link in an optical network may be broadly described by the multiplexing of the WDM signal at the transmission end of the link, the optical path from the multiplexer end to a demultiplexer end of the link, and the demultiplexing of the WDM signal at the receiver end. The point-point link may be the entire transmission part, or it may be part of an optical ring or mesh network.

It is often desirable that a power budget of the transmission link is designed such that variation in the power levels of the individual WDM channels after the de-multiplexing at the receiving end are small.

As a result, it has previously been proposed to design a WDM link in a manner such that the order of wavelength specific filter elements through which the WDM signal passes during the multiplexing and de-multiplexing is reversed between the transmission link ends, to ensure that each individual channel signal passes through the same number of filter elements and consequently experiences similar losses. Such a design is particularly relevant to small channel count, low cost systems which are being designed with a serial multiplexing\demultiplexing unit built out of individual filters.

It has been recognised by the applicant that such a transmission link design has the disadvantage of resulting in a design which is effectively only optimised for a zero transmission link length. In other words, the quality of such a transmission link design typically decreases with increasing transmission link length as variation in WDM power levels increases. This can be attributed to fibre insertion loss variation with wave length along the transmission link. The applicant has farther recognised that this disadvantage is particularly significant to coarse WDM systems, in which the wavelength spacing or spread of the WDM channels can be quite large, e.g. in excess of 100 nm.

The present invention, in at least preferred embodiments, seeks to provide a novel WDM system for link optimisation in coarse WDM systems.

### SUMMARY OF THE INVENTION

In accordance with a first aspect of the present invention there is provided a WDM system comprising a first WDM module having a first multiplexer unit for multiplexing a WDM optical signal, a second WDM module having a first demultiplexer unit for demultiplexing the WDM optical signal, and wherein the system is arranged, in use, such that optical losses experienced by individual channels of the WDM optical signal in the first multiplexing unit and the first demultiplexing unit and optical losses experienced by the channels during un-amplified transmission between the first and second WDM modules are substantially balanced.

Accordingly, a variation in power levels in the WDM signal in the WDM system can preferably be reduced.

In one embodiment, the second WDM module further comprises an optical element for tapping off a management signal from one or more of the channels, and the balancing of the optical losses further accounts for effective optical losses experienced by said one or more channels. The method may further comprise the step of tapping off a management signal from one or more of the channels at the second WDM module, and the balancing of the optical losses further accounts for effective optical losses for said one or more channels. The balancing of the optical losses may further account for a noise impact of the management signal on said one or more channels.

The balancing of the optical losses may further account for effective losses as a result of sensitivities of channel receivers of the second module, and/or limits on transmit powers for the channels.

Preferably, the balancing of the optical losses accounts for a nominal fibre insertion loss. The nominal fibre insertion loss may e.g. be a nominal 20 km fibre insertion loss. 20 km corresponds to a typical maximum distance that may be compensated for when 8 wavelengths across 1470-1610 nm and relatively low loss express insertion loss filters are used. Also, if the received power dynamic range is minimised at 20 km, then the dynamic range experienced at 40 km is the same as it is at 0 km. 40 km corresponds to a typical synchronous optical network (SONET) transmission distance. However, it will be appreciated that the balancing of the optical losses can account for a different nominal fibre insertion loss being in different embodiments, for example, for a nominal 40 km fibre insertion loss.

The balancing of the optical losses may further account for physical design parameters of the WDM modules. The physical design parameters may comprise parameters effecting fibre handling within and outside of the WDM modules, such as locations of ports of the WDM modules or location of filters within the WDM modules.

In one embodiment, the first multiplexer unit and the first demultiplexer units each comprise a plurality of filter elements, and an order of the filter elements in the optical path of the WDM signal is chosen to facilitate the balancing of the optical losses.

The WDM system may be arranged for bi-directional transmission, wherein the first WDM module further comprises a second demultiplexer unit and the second WDM module further comprises a second multiplexer unit, wherein the system is arranged, in use, such that optical losses experienced by individual channels of the WDM optical signal in the second multiplexing unit and the second demultiplexing unit substantially balance optical losses experienced by the channels during un-amplified transmission between the first and second WDM modules.

The balancing in relation to the first multipleximg unit and the first demultiplexing unit may further account for the presence of the second multiplexing unit and the second demultiplexing unit and vice versa.

The WDM system may be arranged as a coarse WDM system with a wavelengths spread greater than 100 nm.

In accordance with a second aspect of the present invention there is provided a method of transmitting a WDM signal from a first WDM module to a second WDM module, the method comprising the step of balancing optical losses experienced by individual channels of the WDM signal during multiplexing and demultiplexing at the first and second WDM modules respectively and optical losses experienced by the channels during un-amplified transmission between the first and second WDM modules.

The method may further comprise the step of tapping off a management signal from one or more of the channels at the second WDM module, and the balancing of the optical losses further accounts for effective optical losses for said one or more channels. The balancing of the optical losses may further account for a noise impact of the management signal on said one or more channels.

The balancing of the optical losses may further account for effective losses as a result of sensitivities of channel receivers of the second module, and/or limits on transmit powers for the channels,

Preferably, the balancing accounts for a nominal 20 km fibre insertion loss.

The balancing of the optical losses may further account for physical design parameters of the WDM modules. The physical design parameters may comprise parameters effecting fibre handling within and outside of the WDM modules, such as locations of ports of the WDM modules or locations of filters within the WDM modules.

The WDM signal may comprise a bi-directional WDM signal and the method may further comprise the step of balancing optical losses experienced by individual channels of the bi-directional WDM signal during de-multiplexing and multiplexing at the first and second WDM modules respectively, and optical losses experienced by the channels during un-amplified transmission along the optical link between the first and second WDM modules.

The balancing in relation to the multiplexing and demultiplexing at the first and second WDM modules may further account for the demultiplexing and multiplexing at the first and second WDM modules, and vice versa.

The WDM signal may comprise a coarse WDM signal with a wavelengths spread greater than 100 nm.

### BRIEF DESCRIPTION OF THE DRAWINGS

Preferred embodiments of the present invention will now be described, by way of example only, with reference to the accompanying drawings.

FIG. 1A is a schematic diagram illustrating an east WDM module embodying the present invention.

FIG. 1B is a schematic diagram illustrating a west WDM module embodying the present invention.

FIG. 2 shows fibre insertion losses as function of WDM channel wavelength for different transmission link lengths embodying the present invention.

FIG. 3A shows fibre insertion losses as a function of WDM channel wavelength in an embodiment of the present invention.

FIG. 3B shows optical losses as a function of WDM channel wavelengths as a result of tapping off of a management signal and further accounting for a noise impact of the management channel on the data, in an embodiment of the present invention.

FIG. 3C shows insertion losses as a function of WDM channel wavelength at filters during multiplexing and demultiplexing in an embodiment of the present invention.

FIG. 3D shows receive power levels as a function of WDM channel wavelength in an embodiment of the present invention.

### DETAILED DESCRIPTION OF THE EMBODIMENTS

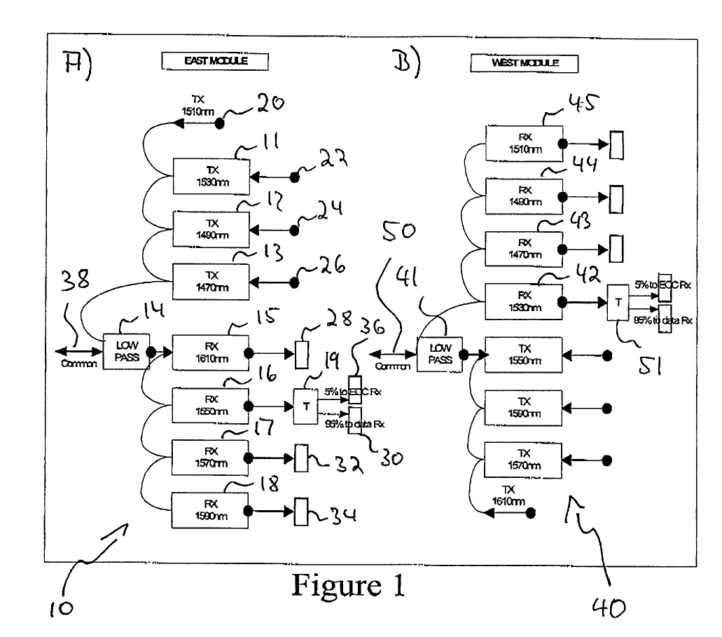

In FIG. 1A, a WDM bi-directional “east” module 10 comprises a plurality of filters 11 to 18. In the example embodiment, the filters 11 to 18 comprise thin film filters, but other filters may be used in different embodiments. The module 10 further comprises four transmission lasers 20, 22, 24 and 26, each set to an individual transmission wavelength, in the example embodiment 1510 nm, 1530 nm, 1490 nm and 1470 nm respectively.

The module 10 further comprises receiver units 28, 30, 32, and 34 for receiving data content on individual wavelength channels, and a further receiver unit 36 for receiving in-band management data content. In the example embodiment, the wavelength of the receiver channels are 1610 nm, 1550 nm, 1570 nm, and 1590 nm at the receiver units 28, 30, 32, and 34 respectively.

In the module 10, the optical signal transmitted from the respective lasers 20, 22, 24, and 26 experience different insertion losses as a result of passing through a different number of the thin film filters 11, 12, 13, and 14, before “leaving” the module 10 as the multiplexed WDM optical signal 38 for transmission into a transmission link/optical network (not shown) to which the module is connected.

Similarly, the optical signals received at the respective receiver units 28, 30, 32, and 34 experience different insertion losses as a result of passing through a different number of the thin film filters 14, 15, 16, 17, and 18, and an optical tap coupler 19.

From FIG. 1A it can been seen e.g. the light transmitted from laser 20 at 1510 nm experiences insertion losses at four of the filters, namely filters 11, 12, 13, and 14 before leaving the module 10 at numeral 38.

At the same time, the optical signal transmitted from laser 24 at 1490 nm experiences insertion losses at three of the thin film filters, namely filter 12, 13, and 14 before leaving the module 10 at numeral 38.

After the WDM signal is transmitted at numeral 38 from the east module 10 and subsequently received at a bi-directional “west” module 40 shown in FIG. 1B, with no amplification along the transmission, further insertion losses at the filter elements 41 to 44 of the module 40 are experienced. As can be seen from FIG. 1B the WDM channel signal at 1510 nm received at numeral 50 at the west module 40 will experience further insertion losses at five thin film filters, namely filters 41 to 45. At the same time, the WDM channel signal at 1490 nm will experience further insertion losses at four thin film filters, namely filters 41 to 44.

It will be appreciated that the above similarly applies also to the WDM channel signals transmitted from the west module 40 to the east module 10.

Thus the order of the thin film filters at the east and west modules 10, 40 determines an optical loss profile of the WTDM channels for multiplexing and demultiplexing.

It has been recognised by the applicants, that if the optical losses are chosen such that the losses in the multiplexing substantially balance the losses in the demultiplexing, through suitable selection of the order of the channel filters, then such a system would minimise the dynamic range of the WDM signal only for a zero transmission link length. It has been recognised by the applicants that fibre insertion losses experienced by the individual WDM channels during transmission along the transmission link can vary significantly between channels. This is found to be of particular relevance where the wavelength spacing or spread of the WDM channels is quite large, e.g. in excess of 100 nm for coarse WDM signals like the one described in the example embodiment as shown in FIGS. 1A and 1B.

It is noted that in the example embodiment shown in FIGS. 1A and 1B, a banded architecture has been used to implement a bi-directional system. Low pass filters 14, 41 are used to “separate” the respective bands at the modules 10 and 40 respectively, i.e. the wavelength signals in one band do not pass through the filters utilised for the wavelengths signals of the other band. However, it will be appreciated by the persons skilled in the art that in different embodiments, a non-banded architecture may be used in e.g. an interleaved architecture. In such embodiments, the balancing in a bi-directional system preferably further accounts for the existence of both multiplexing and demultiplexing filters at each module.

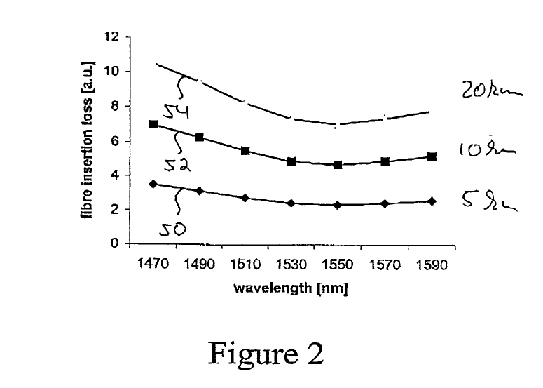

FIG. 2 shows a schematic plot of fibre insertion loss versus WDM channel wavelength for a number of different transmission link lengths, which illustrates the recognised problems.

Firstly, as can be seen from each individual plot 50, 52, 54 in FIG. 2, the fibre insertion loss is not constant across the entire spread of the example WDM signal. Rather, the fibre insertion loss increases on either side of the 1550 nm channel, for a typical silica-based optical fibre link.

Secondly, the dynamic range of the fibre insertion loss across the WDM channels scales with transmission link length. As a result, the disadvantages of prior art transmission link designs which do not take into account the fibre insertion losses along the transmission link become readily apparent, that is such a transmission link design is only “truly” balanced at zero transmission link length, and the dynamic range of the transmission link will increase with increased transmission link length.

The applicants propose that, in a preferred embodiment, the transmission link design is performed for a nominal transmission link length for each WDM multiplexer/demultiplexer unit. It will be appreciated by the person skilled in the art that this enables mass-manufacture of WDM multiplexer/demultiplexer units optimised for the nominal transmission link length, i.e. substantially identical units can be mass-manufactured. The nominal transmission link length chosen for the preferred embodiment is 20 km.

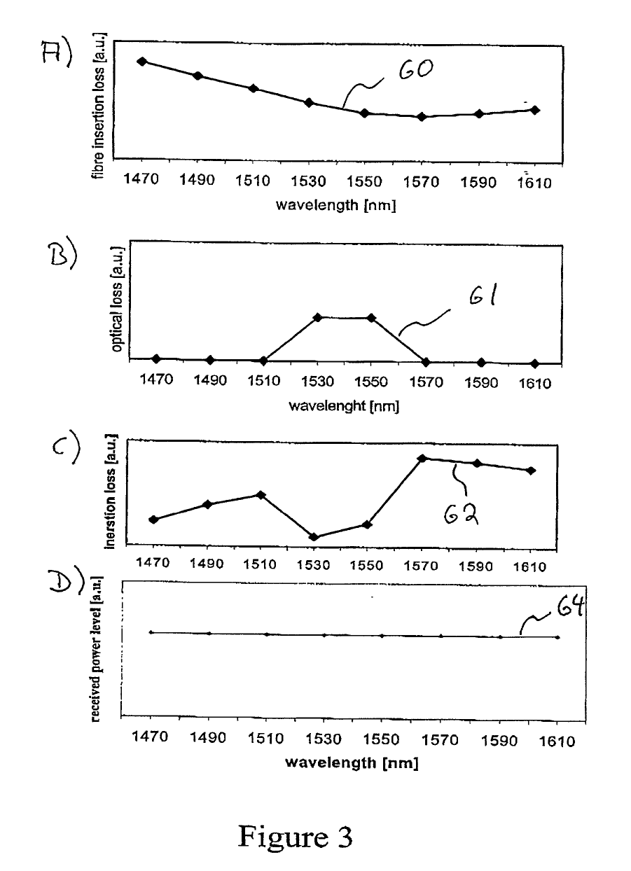

FIGS. 3A-D summarise the transmission link design in accordance with a preferred embodiment of the present invention. In FIG. 3A, plot 60 shows the fibre insertion loss as a function of WDM channel wavelength for the nominal transmission link of 20 km. FIG. 3B shows additional effective losses (plot 61) for the wavelength channels at 1530 nm and 1550 nm due to the tapped off management signal (compare optical elements 19 and 51 in FIGS. 1A and 1B respectively). In the example embodiment, a noise impact of the management signal on the wavelength channels at 1530 nm and 1550 nm is also accounted for in the power balancing.

In FIG. 3C, plot 62 shows the combined optical losses experienced by the individual WDM channels at the thin film filters of the east and west modules as described above with reference to FIGS. 1A and 1B. Plot 62 illustrates the transmission link design embodying the present invention, i.e. in the example embodiment the order and specification of the WDM filters is chosen such that plot 62 substantially balances the optical losses of FIGS. 3A and 3B.

As shown in FIG. 3D, the overall result is that the dynamic range of the WDM signal is minimised, as illustrated by plot 64.

An advantage of the preferred embodiment described is that it does not pull down optical powers in the WDM channels to the lowest common denominator. This would e.g. be the case if compensation was achieved by reducing the power in the lasers for the wavelengths experiencing the smaller fibre insertion losses, or by adding “external” attenuators to increase the optical losses for those wavelengths.

It will be appreciated by the person skilled in the art that there are a number of further optical losses experienced by the individual WDM channel signals, which can be considered for the balancing in different embodiments of the present invention. Those further optical losses include e.g. effective optical losses as a result of the sensitivity of the channel receiver units.

Furthermore, it will be appreciated that in balancing the optical losses through variations in the order of the thin film filters, physical design parameters of the east and west modules 10, 40 respectively can be considered. That is, they may influence the ultimate choice of order, in a trade-off between reducing the dynamic range of the WDM signal versus physical design parameters such as fibre handling issues and the location of ports on a housing of the module, which have direct consequences for the ease and costs of manufacturing of the modules.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication the word “comprising” is used in the sense of “including”, i.e. the features specified may be associated with further features in various embodiments of the invention.

1. A WDM system comprising:
a first WDM module having a first multiplexer unit for multiplexing a WDM optical signal,
a second WDM module having a first demultiplexer unit for demultiplexing the WDM optical signal, and
wherein the system is arranged, in use, such that optical losses experienced by individual channels of the WDM optical signal in the first multiplexing unit and the first demultiplexing unit and optical losses experienced by the channels during un-amplified transmission between the first and second WDM modules are substantially balanced.

2. A WDM system as claimed in claim 1, wherein the second WDM module further comprises an optical element for tapping off a management signal from one or more of the channels, and the balancing of the optical losses further accounts for effective optical losses experienced by said one or more channels.

3. A WDM system as claimed in claim 2, wherein the balance of the optical losses further accounts for a noise impact of the management signal on said one or more channels.

4. A WDM system as claimed in claim 1, wherein the balancing of the optical losses further accounts for effective losses as a result of sensitivities of channel receivers of the second module, and/or limits on transmit powers for the channels.

5. A WDM system as claimed in claim 1, wherein the balancing of the optical losses accounts for a nominal 20 km fibre insertion loss.

6. A WDM system as claimed in claim 1, wherein the balancing of the optical losses further accounts for physical design parameters of the WDM modules.

7. A WDM system as claimed in claim 6, wherein the physical design parameters comprise parameters effecting fibre handling within and outside of the WDM modules.

8. A WDM system as claimed in claim 7, wherein the parameters comprise locations of ports of the WDM modules or locations of filters within the WDM modules.

9. A WDM system as claimed in claim 1, wherein the first multiplexer unit and the first demultiplexer units each comprise a plurality of filter elements, and an order of the filter elements in the optical path of the WDM signal is chosen to facilitate the balancing of the optical losses.

10. A WDM system as claimed in claim 1, wherein tie WDM system is arranged for bi-directional transmission, wherein the first WDM module further comprises a second demultiplexer unit and the second WDM module further comprises a second multiplexer unit, wherein the system is arranged, in use, such that optical losses experienced by individual channels of the WDM optical signal in the second multiplexing unit and the second demultiplexing unit substantially balance optical losses experienced by the channels during un-amplified transmission between the first and second WDM modules.

11. A WDM system as claimed in claim 10, wherein the balancing in relation to the first multiplexing unit and the first demultiplexing unit further accounts for the presence of the second multiplexing unit and the second demultiplexing unit and vice versa.

12. A WDM system as claimed in claim 1, wherein the WDM system is arranged as a coarse WDM system (C WDM) with a wavelengths spread greater than 100 nm.

13. A method of transmitting a WDM signal from a first WDM module to a second WDM module, the method comprising the step of:
balancing optical losses experienced by individual channels of the WDM signal during multiplexing and demultiplexing at the first and second WDM modules respectively and optical losses experienced by the channels during un-amplified transmission along an optical link between the first and second WDM modules.

14. A method as claimed in claim 13, wherein the method further comprise the step of tapping off a management signal from one or more of the channels at the second WDM module, and the balancing of the optical losses further accounts for effective optical losses for said one or more channels.

15. A method as claimed in claim 14, wherein the balancing of the optical losses further accounts for a noise impact of the management signal on said one or more channels.

16. A method as claimed in claim 13, wherein the balancing of the optical losses further accounts for effective losses as a result of sensitivities of channel receivers of the second WDM module and/or limits on transmit powers for the channels.

17. A method as claimed in claim 13, wherein the balancing accounts for a nominal 20 km fibre insertion loss.

18. A method as claimed in claim 13, wherein the balancing of the optical losses further accounts for physical design parameters of the WDM modules.

19. A method as claimed in claim 18, wherein the physical design parameters comprise parameters effecting fibre handling within and outside of the WDM modules.

20. A method as claimed in claim 19, wherein the parameters comprise locations of ports of the WDM modules or locations of filters within the WDM modules.

21. A method as claimed in claim 13, wherein the WDM signal comprises a bi-directional WDM signal, and the method further comprises the step of:
balancing optical losses experienced by individual channels of the bi-directional WDM signal during demultiplexing and multiplexing at the first and second WDM modules respectively, and optical losses experienced by the channels during un-amplified transmission along the optical link between the first and second WDM modules.

22. A method as claimed in claim 21, wherein the balancing in relation to the multiplexing and demultiplexing at the first and second WDM modules further accounts for the demultiplexing and multiplexing at the first and second WDM modules respectively, and vice versa.

23. A method as claimed in claim 13, wherein the WDM signal comprises a coarse WDM (C WDM) signal with a wavelengths spread greater than 100 nm.
